(19) United States
(12) Patent Application Publication
(10) Pub. No.: US 2025/0348849 A1
(43) Pub. Date: Nov. 13, 2025

(54) PROACTIVE EQUIPMENT MACHINE HEALTH MONITORING AND SELF-HEALING USING SENSORS & ARTIFICIAL INTELLIGENCE (AI)

(71) Applicant: PepsiCo, Inc., Purchase, NY (US)

(72) Inventors: Kazim KHAN, Nanuet, NY (US); Terry Tae-il CHUNG, New Fairfield, CT (US); Gino MALPARTIDA, Norwalk, CT (US); Bill LYVER, Yonkers, NY (US)

(73) Assignee: PepsiCo, Inc., Purchase, NY (US)

(21) Appl. No.: 18/660,374

(22) Filed: May 10, 2024

(51) Int. Cl. G06Q 10/20; G06N 20/00

(52) U.S. Cl. CPC G06Q 10/20; G06N 20/00

(57) ABSTRACT

Disclosed herein are system, method, and computer program product embodiments for proactive equipment machine health monitoring and self-healing using sensors & AI, comprising: applying a machine learning model to a first sensor reading, wherein the first sensor reading comprises a condition associated with a beverage system; predicting a repair action based on applying the machine learning model, wherein the repair action comprises a step to address the condition at the beverage system; executing the repair action at the beverage system; and generating an output by applying the machine learning model to a second sensor reading.

### BACKGROUND

In a food service environment, machines may be used for a variety of tasks such as food preparation, food storage, beverage storage, and sales. These machines often include numerous parts that may fail as a result of manufacturing defects, user error, or environmental exposure. Repairing the machines is often a costly and laborious task for a variety of reasons. First, a failure needs to be identified. This often does not occur until a third party is able to physically inspect the machine. Second, the repair may be delayed because the third part may not have the means to fix the error upon arriving for an inspection. In addition to errors, machines often require preventative maintenance to extend their lifetimes. Similar to error detection, preventative maintenance also requires third party inspection.

In some instances, a machine can communicate the error or failure over a network to a central server. However, an entity responsible for thousands or millions of machines may encounter significant network delays attempting to communicate this data. Thus, there is a need to: (1) detect and diagnose errors at the network edge; (2) perform repairs at the network edge without engaging third parties; and (3) identify and execute preventative maintenance at the network edge. Solving these problems not only extends the life of the machine, but also reduces network latency and bottleneck formation for machines communicating on a network.

### BRIEF SUMMARY

Disclosed herein are system, apparatus, device, method and/or computer program product embodiments, and/or combinations and sub-combinations thereof, for proactive equipment machine health monitoring and self-healing using sensors & AI. Some embodiments relate to a method applying a machine learning model to a first sensor reading, where the first sensor reading comprises a condition associated with a beverage system. The method also includes predicting a repair action based on applying the machine learning model, where the repair action comprises a step to address the condition at the beverage system. The method further includes executing the repair action at the beverage system. Additionally, the method includes generating an output by applying the machine learning model to a second sensor reading.

Some embodiments relate to a system with a memory and at least one processor coupled to the memory. The at least one processor is configured to apply a machine learning model to a first sensor reading, where the first sensor reading comprises a condition associated with a beverage system. The at least one processor is further configured to predict a repair action based on applying the machine learning model, where the repair action comprises a step to address the condition at the beverage system. The at least one processor is further configured to execute the repair action at the beverage system. Furthermore, the at least one processor is configured to generate a result by applying the machine learning model to a second sensor reading

Some embodiments relate to a non-transitory computer-readable device having instructions stored thereon. When the instructions are executed by at least one computing device, the instructions cause the at least one computing device to perform operations that include applying a machine learning model to a first sensor reading, where the first sensor reading comprises a condition associated with a beverage system. The method also includes predicting a repair action based on applying the machine learning model, where the repair action comprises a step to address the condition at the beverage system. The method further includes executing the repair action at the beverage system. Additionally, the method includes generating an output by applying the machine learning model to a second sensor reading.

### BRIEF DESCRIPTION OF THE DRAWINGS

The accompanying drawings are incorporated herein and form a part of the specification.

FIG. 1 depicts an exemplary beverage equipment environment for proactive machine health monitoring and self-healing, according to some embodiments.

FIG. 2 depicts a block diagram of a machine learning module, according to some embodiments.

FIG. 3 depicts an exemplary interface for a sensor alert, according to some embodiments, according to some embodiments.

FIG. 4 depicts an exemplary interface for sensor alert details, according to some embodiments.

FIG. 5 depicts an exemplary interface for sensor reading details, according to some embodiments.

FIG. 6 depicts an exemplary interface for sensor reading details, according to some embodiments.

FIG. 7 depicts a flowchart illustrating a method for using sensor data to take corrective action, according to some embodiments.

FIG. 8 depicts a flowchart illustrating a method for proactive equipment machine health monitoring and self-healing using sensors and AI, according to some embodiments.

FIG. 9 is a flowchart illustrating an example method for locally retraining a machine learning model, according to some embodiments.

FIG. 10 is a flowchart illustrating an example method for remotely retraining a machine learning model, according to some embodiments.

FIG. 11 is a flowchart illustrating an example method for receiving a repair action from a cloud server, according to some embodiments.

FIG. 12 is a flowchart illustrating an example method for sending an alert, according to some embodiments.

FIG. 13 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for proactive equipment machine health monitoring and self-healing using sensors & AI. The beverage system described herein may include at least one sensor providing sensor data and a machine learning model configured to analyze the sensor data. The analysis may determine whether the beverage system has encountered or will encounter (i.e., predictively) certain conditions in one more components of the beverage system. For example, the model may detect that the beverage system is in an error state (e.g., a component is in need of repair) or requires preventative maintenance (e.g., a component may malfunction soon). In some embodiments, the condition may indicate that one or more of the components are operating normally (e.g., as expected).

In some embodiments and in contrast to prior art systems, the error states detected by the model are not statically defined or predetermined. For example, in prior art systems, a beverage system may determine that a component is in an error state if the temperature of the component is above a predefined threshold, such as a threshold that is established by a manufacturer of the beverage system. This predefined threshold may also be static in nature and remain unchanged through the lifespan of the beverage system. In contrast, the model of the present disclosure may operate and determine error states without relying on defined conditions. For example, the model may rely on information from a combination of sensors of the beverage system to dynamically detect operating conditions of beverage system components, and determine that one or more of the components is an error state based on the combined information. That is, as opposed to detecting that a component is operating outside of a predefined acceptable temperature threshold (i.e., a static error condition), the model may determine that the component is in an error state despite operating within conventionally acceptable temperature thresholds (i.e., a dynamic error condition). This error state is based on the model processing information from multiple sensors to determine whether the operating condition of a component is acceptable.

This process is also used to predict when preventative maintenance for a component is needed. For example, the model may use data from one or more sensors to predict that a component of the beverage system requires preventative maintenance. In contrast, prior art systems may rely solely on component lifespan to determine when preventative maintenance is required. For example, a prior art system may replace a motor every six months. This preventative maintenance threshold (e.g., six months) may be static and remain unchanged throughout the life of the beverage system. However, the beverage system of the present disclosure may leverage a machine learning model to analyze sensor data in order to detect when preventative maintenance is required. For example, the model may learn that certain sensor readings indicate a component is likely going to fail, and therefore preventative maintenance is needed. Leveraging the model in this way allows for tailored preventative maintenance to be identified. Whereas a prior art system may leverage static thresholds to identify preventative maintenance, here, the optimal thresholds for when preventative maintenance may be learned. As a result, beverage systems of the present disclosure may each have their own custom preventative maintenance schedules learned via their respective machine learning models.

The model may be further configured to generate actions for a self-healing process. The self-healing actions may be repairs generated based on the detected condition. For example, the model may detect that the temperature within the beverage system is rising beyond normal limits or predict that the temperature will rise. In response, the model may predict that an action or a series of actions, such as engaging an air conditioner, are needed to reduce the temperature. The model may then cause the system to engage the air conditioning system and monitor subsequent sensor data to determine if the action worked. The beverage system may evaluate the action by re-applying the model to subsequent sensor data and generating an output. The output may indicate whether the action fixed the error. As will be discussed later, the model may predict and recommend the most environmentally friendly actions.

The beverage system may use the sensor data, recommended actions, and output(s) to update the machine learning model. For example, the machine learning model may retrain each time it employs an action and determines an output. In some embodiments, the system may transmit the sensor data to a cloud server that also includes a machine learning model. The cloud server model may also analyze the input data to generate an action. Although both the beverage system and cloud server may include machine learning models, using a model at the edge of the network, on the beverage system, improves network throughput and repair time by not having to communicate over a network with the cloud server. In some embodiments, communicating with the cloud server may be beneficial, such as when the beverage system fails to correct an error, additional information is desirable, or additional processing is required. For example, the machine learning model in the cloud server may be a more robust model with access to faster processing power, and thus may be able to more rapidly diagnose an error or generate an action. In some embodiments, the cloud server machine learning model may be updated more frequently than the model at the beverage system. Thus, using the cloud server model may allow for more robust sensor analysis and action generation.

The beverage system may further communicate sensor data, generated actions, and outputs to client devices. Client devices may be associated beverage system owners, users, repair entities, or any other designated party. For example, the action may involve an external repair entity. Here, the beverage system may transmit a message to a device associated with the repair entity, providing them details regarding the error, such as a link to access the machine learning model on the beverage system, and the likely action to fix the error. Such an embodiment will significantly reduce the time and cost associated with repairs. In this manner, temporary access to the model's capabilities on the beverage system may be provided to an external device so that the external device can view and select any of recommended actions. The access may further include viewing updates as repairs are being made to the beverage system. In some embodiments, the action may require ordering a new or replacement part for the beverage system. In some embodiments, the model may automatically generate an order form based on the recommended action. Here, the beverage system may directly order the part based on the order form.

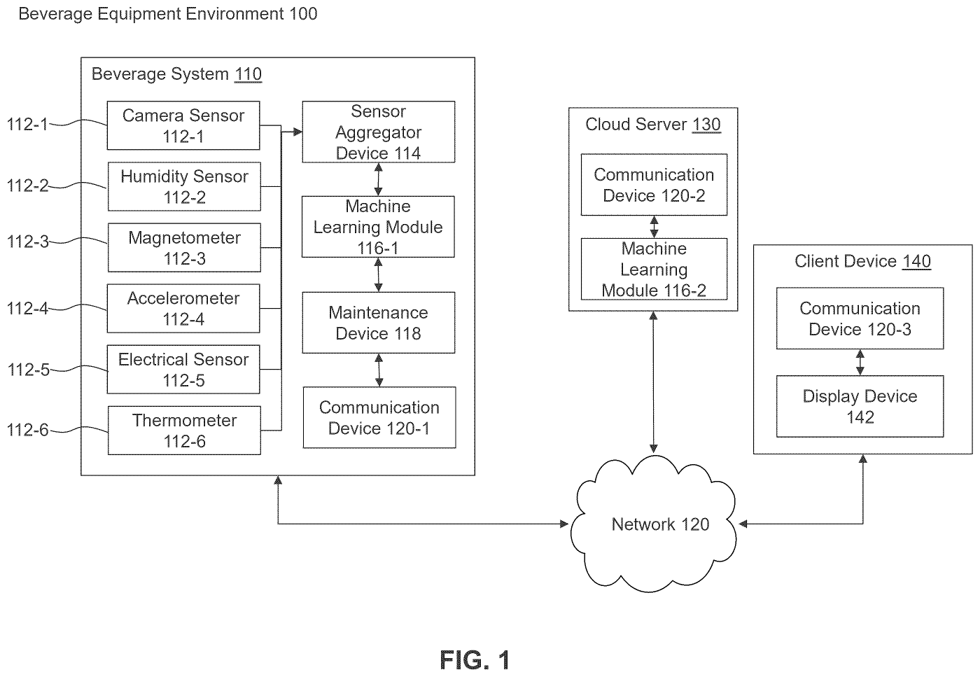

FIG. 1 depicts an exemplary beverage equipment environment 100 for proactive equipment machine health monitoring and self-healing using sensors & AI, according to some embodiments. Beverage equipment environment 100 includes beverage system 110, network 120, cloud server 130, and client device 140.

Beverage system 110 may be any device capable of housing beverages. In some embodiments, beverage system 110 may be a cooler to store pre-packaged beverages and other items (e.g., a vending machine). In some embodiments, beverage system 110 may house and dispense beverages (e.g., a drink dispenser). Beverage system 110 includes sensor 112, sensor aggregator device 114, machine learning module 116-1, maintenance device 118, and communication device 120-1.

Sensor 112 may be any device capable of gathering data from an environment, such as beverage equipment environment 100. Sensor 112 may be a camera (internally and/or externally facing), thermometer, accelerometer, humidity sensor, noise sensor (e.g., a microphone), magnetometer, voltmeter, electrical current sensor, light sensor, infrared (IR) sensor, vibration sensor, GPS, flowmeter, tilt detector, loadcell, or proximity sensor, but is not limited to the sensor types listed. Sensor 112 may be configured to gather data about the internal (e.g., components) and external environment of beverage system 110. For example, sensor 112 may gather data about beverage system's 110 internal conditions, such as temperature or voltage usage. In some embodiments, sensor 112 may gather data about the external environment where beverage system 110 is located, such as ambient temperature, humidity level, and detection of nearby objects. Sensor 112 may further gather data including levels of energy consumption at beverage system 110. For example, sensor 112 may gather energy consumption data when beverage system 110 is in different states (e.g., idling, dispensing a beverage). Beverage system 110 may include camera sensor 112-1, humidity sensor 112-2, magnetometer 112-3, accelerometer 112-4, electrical sensor 112-5, and thermometer 112-6. Beverage system 110 may include any number or combination of sensors. Each sensor 112 may send data to sensor aggregator device 114.

Sensor aggregator device 114 may receive data from sensor 112. Sensor aggregator device 114 may format received sensor data. For example, sensor aggregator device 114 may standardize the format of sensor data. In some embodiments, this may involve manipulating output from each sensor 112 so that each output has the same dimensionality. For example, sensor aggregator device 114 may upsample, downsample, filter, and/or transform data from each sensor 112. This may be beneficial so that the data may be used together and/or compared, for example, during training of the machine learning model provided by machine learning module 116-1. Sensor aggregator device 114 may be configured to label the source of the sensor data. For example, sensor aggregator device 114 may label images or video from camera 112-1 with a tag “camera.” This may be useful so that other components of beverage equipment environment 100 can determine the source of the data.

In addition to labeling the type of sensor 112, sensor aggregator device 114 may append a component identifier to data provided by a particular component, such as a sensor identifier to data provided by sensor 112. For example, beverage system 110 may include two camera sensors 112. Each camera sensor 112 may have a unique identifier. Sensor aggregator device 114 may append the identifier of each camera sensor 112 to the data from the respective camera sensor 112. This may be beneficial to determine which images or video came from which camera sensor 112. Sensor aggregator device 114 may transmit the sensor data to machine learning module 116-1.

Machine learning module 116-1 may include one or more machine learning model(s) trained to analyze sensor data, such as data from sensor 112. Machine learning module 116-1 may include a model for each sensor 112 at beverage system 110. For example, machine learning module 116-1 may include a first model to input and generate predictions for image and video data from camera sensor 112-1, and a second model to input and generate predictions for temperature readings generated by thermometer 112-6.

Machine learning module 116-1 may receive data from sensor aggregator device 114, and use the sensor data as an input to a machine learning model. The output may be a prediction as to whether the sensor data is normal or includes an anomaly based on comparison to current or preventative threshold conditions. The output may further include predicted actions to address detected anomalies within the sensor data.

Current threshold conditions may include conditions that machine learning module 116-1 uses to determine whether one or more components of beverage system 110 is within a threshold for initiating reparative actions. The current threshold conditions may be identified by analyzing data from one or more sensors 112. By leveraging machine learning module 116-1 to analyze sensor data, including data from multiple sensors, beverage system 110 may detect errors that individual sensors may be unable to identify alone. For example, acceleration sensor 112-4 and magnetometer 112-3 may detect elevated vibration and magnetism readings respectively, but these readings may still be within predefined normal limits. However, machine learning module 116-1 may analyze this data, detect that beverage system 110 is likely experiencing a motor issue, and predict one or more reparative actions to fix the motor issue. As an additional example, thermometer 112-6 may output normal temperature readings, but humidity sensor 112-1 may output elevated humidity readings. By themselves, the individual sensor readings may not indicate there is an issue with beverage system 110. For example, the elevated humidity could be attributed to the weather. However, by combining sensor data and leveraging machine learning module 116-1, certain conditions, previously discoverable only upon physical inspection, such as a fluid leak, may be detected. Moreover, machine learning module 116 may be used to modify threshold conditions based on beverage system's 110 use, location, products dispensed, or a combination thereof, all of which may be tracked and then analyzed. In addition, as machine learning module 116 learns it may be able to suggest whether additional sensors 112 may be beneficial or whether certain sensors may be redundant. This will optimize performance, reduce energy consumption, reduce cost, and reduce the environmental footprint or equipment in the system.

Current threshold conditions may also be determined from sensor data that may be more challenging to quantify. For example, camera sensor 112-1 may be configured to monitor the environment where beverage system 110 is located. Machine learning module 116-1 may input the image and video data from camera sensor 112-1 to detect a current threshold condition. For example, beverage system 110 may have been stolen, and machine learning module 116-1 may recognize that the scene captured by camera sensor 112-1 has changed. In this example, machine learning module 116-1 may generate and output a notification or alert based on the detected location change. Moreover, machine learning module 116 may be trained to optimize sensor readings such that beverage system 110 may function and readings may continually be taken while certain sensors 112 are down.

Machine learning module 116-1 may be configured to update current threshold conditions. The current threshold conditions may be updated by retraining the machine learning model(s), as will be discussed below. Updating current threshold conditions improves error detection by reducing the number of false positives. A false positive may occur when machine learning module 116-1 incorrectly predicts that a component(s) at beverage system 110 has failed based on a comparison between sensor data and a respective current threshold condition. By retraining and updating current threshold conditions, the number of false positives will be reduced. In turn, this will save network resources associated with having to communicate the false positive to other entities on network 120. This will also save physical resources associated with mistakenly ordering new or replacement parts, or having to perform a physical inspection in response to the false positive. Additionally, beverage system 110 will operate more efficiently because a false positive causing beverage system 110 to be shut down or operate at reduced level, will be avoided.

Preventative threshold conditions include conditions determined and updated by machine learning module 116-1 for determining whether one or more components of beverage system 110 is within a threshold for initiating preventative action. Machine learning module 116-1 may be configured to dynamically update the preventative threshold conditions based on retraining of the machine learning model(s) in order to provide more efficient and accurate determinations of when beverage system 110 is need of repair. In some embodiments where beverage system 110 is performing these determinations independently (i.e., on the edge), the use of dynamically updated conditions enables more efficient maintenance of the beverage system 110 and is more likely to prevent the breakdown of components. For example, performing autonomous preventative maintenance on the network edge alleviates the need of having to communicate beverage system's 110 status or current condition. Additionally, the autonomous preventative maintenance increases beverage system's 110 efficiency. Since beverage system 110 does not have to be deactivated or operated at reduced capacity, due to an error from failing to perform preventative maintenance, beverage system 110 may continue operate at peak efficiency, for longer stretches of time.

Sensor data relates to the status of one or more components. Examples of status include but are not limited to product status (e.g., visual detection of products in the beverage system 110), humidity, magnetic fields, physical movement (e.g., whether the beverage system 110 is experiencing external or internal movement from a component), voltage and current information, and temperature data. Machine learning module 116-1 may be trained to predict the status of the one or more components within beverage system 110, based on the sensor data. As will be discussed in more detail below, machine learning module 116-1 may be trained to correlate received sensor data with one or more conditions within beverage system 110, and may be trained to generate these correlations dynamically, without any predefined input.

For example, for sensor data that includes temperature data, machine learning module 116-1 may detect that the temperature output by thermometer 112-6 is too high. Machine learning module 116-1 may be configured to analyze data from multiple sensors 112 in order to predict a state or condition of beverage system 110 or beverage equipment environment 100. For example, machine learning module 116-1 may analyze data from a vibration sensor 112 and a noise sensor 112 to predict that there is an issue with a motor at beverage system 110. Additionally, machine learning module 116-1 may analyze data from humidity sensor 112-1 and thermometer 112-6 to predict that there is an environmental issue where beverage system 110 is located.

For example, for sensor data that includes magnetic data, machine learning module 116-1 may detect a high level of magnetism that may be associated with a motor or electrical failure.

For example, sensor data may include visual data of a beverage dispensed by beverage system 110. Machine learning module 116-1 may input the visual data and detect, based on the color and fill level of the dispensed beverage, that there is an issue with the beverage ingredients, carbonation, or a combination thereof. Visual data may also include information about beverage system's 110 surroundings. For example, camera sensor 112-1 may capture data about beverage system's 110 environment. Machine learning module 116-1 may use this data to make various predictions such as whether beverage system 110 has or is moving. As another example, visual data, flow rate data, and other data may be used as part of a beverage quality assurance mechanism to ensure that beverage system 110 is properly dispensing beverages (e.g., carbonated beverages with the proper amount of carbonation or right concentration of syrup). That is to say, machine learning module 116 may ensure that component performance thresholds account for optimal product quality and include that as part of its component health analysis.

Visual data and audio data, alone or in combination, may also be used to identify: (1) the number of users that interact with beverage system 110; and (2) the sentiment of users that interact with beverage system 110.

For sensor data that includes accelerometer data, machine learning module 116-1 may be trained to detect excessive movement based on a user shaking the machine or excessive movement based on a motor or other mechanical malfunction.

For example, for sensor data that includes electrical data, machine learning module 116-1 may be trained to detect voltage and current level greater than predefined thresholds. Excess voltage and current levels may indicate an issue with an electrical component or system at beverage system 110.

Machine learning module 116-1 may be further configured to generate an action for self-healing in response to applying the machine learning model(s) sensor data. As stated above, the sensor data may be produced by one or more sensors 112 of beverage system 110. The sensor data may include one or more of visual data, temperature data, humidity data, vibration data, electrical data, noise data, location data, magnetism data, accelerometer data, fluid data, and light data. In some embodiments, if machine learning module 116-1 predicts that beverage system 110 is in or will encounter an error state, machine learning module 116-1 may generate an action to fix or prevent the error.

For example, if machine learning module 116-1 uses data from multiple sensors to identify one or more components (e.g., a primary fluid system) has failed, machine learning module 116-1 may predict that beverage system 110 requires reparative maintenance, such as engaging a secondary fluid system.

Additionally, machine learning module 116-1 may predict that a component, e.g., motor, at beverage system 110 will fail (e.g., within a predetermined period of time), machine learning module 116-1 may determine that beverage system 110 requires a preventative or mitigating action. Preventative actions may be determined by machine learning module 116-1 and performed by beverage system 110 to prevent a predicted upcoming failure with regards to one or more components (e.g., a motor). For example, machine learning module 116-1 may detect that the temperature and humidity within beverage system 110 are rising at an abnormal rate. In response, machine learning module 116-1 may predict an action for beverage system 110 to engage an air conditioner to reduce the temperature and humidity. As another example, machine learning module 116-1 may identify, based on historical data, that a light source within beverage system 110 fails within 6 months, and that the current light source was installed 5 months ago. In order to avoid a failure at the light source, machine learning module 116-1 may determine that preventative maintenance is required.

In some embodiments, preventative maintenance may involve components (e.g. new parts) or entities (repair personnel) external to beverage system 110. In these scenarios, machine learning module 116-1 may predict actions to avoid the predicted failure while also prolonging beverage system's 110 operation. For example, machine learning module 116-1 may predict that a motor at beverage system 110 is likely going to fail and that a new motor is required. In this example, a mitigating action such as reducing the motor's usage may be executed until the replacement can be performed. By predicting and executing mitigating actions, beverage system 110 may continue to operate in a safe manner until one or more components are replaced or a physical inspection is performed.

Machine learning module 116-1 may assign each generated action a confidence score associated with a probability that the action will address the issue indicated by the sensor data. For example, machine learning module 116-1 may generate three actions: (1) activate fan; (2) cycle power; and (3) deactivate lights, with respective confidence scores: (1) 80%; (2) 15%; and (3) 5%. Machine learning module 116-1 may select the action with the highest confidence score. In some embodiments, beverage system 110 may execute actions with confidence scores above a certain threshold. For example, an action may be executed when its confidence score is greater than 50%.

In some embodiments, machine learning module 116-1 may consider energy consumption when selecting an action. For example, machine learning module 116-1 may be configured to predict energy consumption levels associated with each action. In some embodiments, machine learning module 116-1 may select an action with low energy consumption (e.g., environmentally friendly). For example, machine learning module 116-1 may predict two solutions, order a new fluid system and power cycle beverage system 110. The solutions may have respective confidence scores of 65% and 45%, however, the new fluid system may have to be shipped from a location 500 miles away from beverage system 110. In contrast, power cycling beverage system 100 may consume little energy. In response, machine learning module 116-1 may first power cycle beverage system 110 based on the reduced energy consumption associated with executing the action. This may be beneficial not only to save resources, but also to be environmentally friendly.

As will be discussed further below, beverage system 110 may contact cloud server 130 and/or client device 140. These communications may occur in various circumstances. For example, if beverage system 110 predicts an action with a confidence score above a threshold, indicating the action is likely to fix the error, beverage system 110 may communicate this to cloud server 130 and/or client device 140. This may be beneficial to apprise cloud server 130 and/or client device 140 of beverage system's 110 status. In some embodiments, beverage system 110 may send a communication when confidence scores for predicted actions fall below a certain threshold. For example, if the predicted actions have low confidence scores, beverage system 110 may communicate this information to cloud server and/or client device 140 in order to receive an action to perform. For example, cloud server 130 may apply its local machine learning model to the sensor data, in order to predict a solution. Additionally, client device 140 may respond to beverage system's 110 communication, with a selected repair action to perform. These communications may occur when confidence scores for generated actions fall below a certain threshold. The selected action may be sent to maintenance device 118 to perform.

As will be discussed in more detail below, machine learning module 116-1 may update or retrain the machine learning model(s). Training may involve iterating over examples including sensor data and predicting: (1) whether the sensor data indicates beverage system 110 is encountering an error and/or requires preventative maintenance; and (2) predicting an action to address the error and/or preventative maintenance. Each example may have a corresponding label listing the condition (e.g., error present, preventative maintenance required) in the sensor data, and a correct action to take. Machine learning module 116-1 may retrain the model at any frequency. For example, training may occur daily, weekly, or monthly. In some embodiments, machine learning module 116-1 may retrain each time an anomaly (e.g., an error, preventative maintenance required) is detected and repaired.

Maintenance device 118 may be used to execute the action generated by machine learning module 116-1. For example, maintenance device 118 may actuate a fan system at beverage system 110 to reduce the temperature and/or humidity. In some embodiments, maintenance device 118 may actuate a lighting system or power cycle beverage system 110.

Actions generated by machine learning module 116-1 may be tailored based on the configuration of beverages system 110. For example, one beverage system 110 may have an internal fan as discussed above, while a second beverage system 110 does not. Machine learning module 116-1 may be configured to generate actions that beverage system 110 is capable of performing. As will be discussed below, machine learning module 116-1 may leverage cloud server 130 to generate actions.

As stated above, machine learning module 116-1 may generate repair actions that involve external action. For example, machine learning module 116-1 may determine that an external maintenance entity is required to fix an issue at beverage system 110. Machine learning module 116-1 may generate an alert including details of the repair or maintenance such as: (1) sensor data; (2) component(s) involved; (3) suggested repair or maintenance; (4) beverage system 110 location; and (5) beverage system 110 access details. Beverage system 110 may send the alert to the external maintenance entity via network 120. Machine learning module 116-1 may be further configured to identify additional or replacement parts for beverage system 110. For example, machine learning module 116-1 may determine that a part at beverage system 110 has failed and cannot be fixed locally. In some embodiments, machine learning module 116-1 may obtain, and then fill out an order form for the component(s). Beverage system 110 may execute the order via network 120. In some embodiments machine learning module 116-1 may use GPS location data to suggest recyclable replacement parts compatible with local regulations. Machine learning module 116-1 may further use GPS location data to suggest nearby locations where parts from beverage system 110 may be recycled, as opposed to being thrown away.

In some embodiments, a legacy beverage system 110 may be upgraded by installing sensors 112, sensor aggregator device 114, machine learning module 116-1, maintenance device 118, and communication device 120-1. Sensor aggregator device 114, machine learning module 116-1, maintenance device 118, and communication device 120-1 may be programmed using object-oriented modules to enable communication with each other as well as sensor(s) 112.

Beverage system 110 may communicate with cloud server 130 and client device 140 via network 120. For example, beverage system 110 may communicate alerts, notifications, statuses, or other messages with cloud server 130 and/or client device 140. In some embodiments, beverage system 110 may communicate a heartbeat message at a predefined interval to cloud server 130 or client device 140, or both. The heartbeat message may include the latest analysis by machine learning module 116-1 of data from each sensor 112. Beverage system 110 may send a communication to cloud server 130 and/or client device 140 when machine learning module 116-1 detects an error based on data from sensor 112. Beverage system 110 may be configured to send data from sensors 112 to cloud server 130 when an error is detected and: (1) machine learning module 116-1 was unable to generate an action; (2) generated actions had confidence scores below a predefined threshold; or (3) the action created by machine learning module 116-1 executed by maintenance device 118 failed to fix the error. Beverage system 110 may additionally communicate with cloud server 130 and/or client device 140 when an error is fixed and/or preventative maintenance performed.

Beverage system 110 may further communicate with cloud server 130 each time machine learning module 116-1 retrains a machine learning model. Beverage system 110 may send the updated model to cloud server 130, for use by cloud server 130 and throughout network 120. This is beneficial so that cloud server 130, and other beverage systems 110, have access to the latest and most effective predictive capabilities based on the sensor data and resulting trained model(s). Beverage system 110 may also send training data used to update the model. The training data may include data from sensor(s) 112, a prediction by machine learning module 116-1 whether each data includes an anomaly, and if so, a predicted action that addressed the anomaly within the sensor data. This sensor data may originate from one beverage system 110, or multiple beverage systems 110 throughout a local, regional, national, and/or global network.

Beverage system 110 may use communication device 120-1 to send and receive communications. Communication device 120-1 may be configured to communicate with cloud server 130 and client device 140 via network 120. Communication device 120-1 may comprise any suitable network interface capable of transmitting and receiving data, such as, for example a modem, an Ethernet card, a communications port, or the like. Communication device 120-1 may be able to transmit data using any wireless transmission standard such as, for example, Wi-Fi, Bluetooth, cellular, or any other suitable wireless transmission.

Network 120 may be any type of computer or telecommunications network capable of communicating data, for example, a local area network, a wide-area network (e.g., the Internet), or any combination thereof. The network may include wired and/or wireless segments.

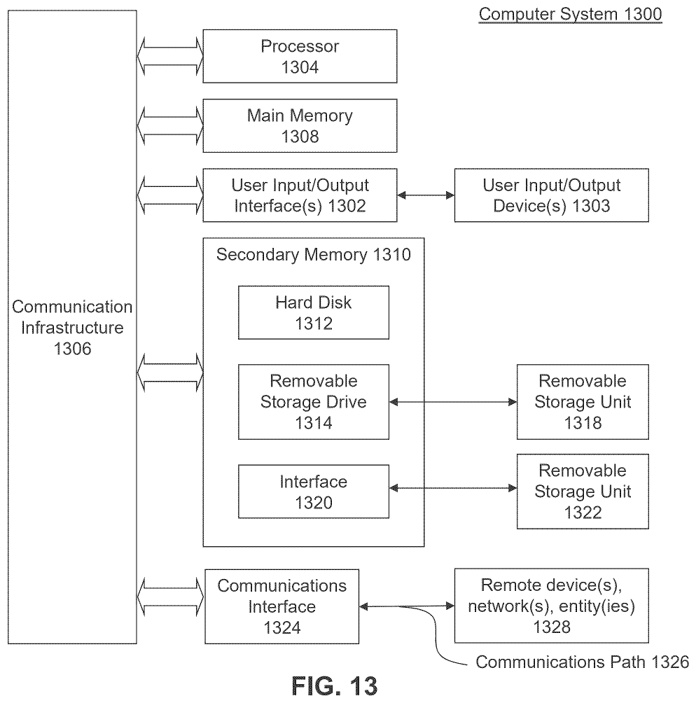

Cloud server 130 may be implemented using one or more servers and/or databases. In some embodiments, cloud server 130 may be implemented using a computing device such as a desktop workstation, laptop or notebook computer, netbook, tablet, smart phone, and/or other computing device. In some embodiments, cloud server 130 may be implemented as an application in an enterprise computing system and/or a cloud-computing system. In some embodiments, cloud server 130 may be a computer system such as computer system 1300 described with reference to FIG. 13. Although a single cloud server 130 is depicted, beverage equipment environment 100 may include multiple cloud servers 130.

Cloud server 130 includes communication device 120-2 and machine learning module 116-2. Cloud server 130 may leverage machine learning module 116-2 to analyze received data from beverage system 110. In some embodiments, cloud server 130 may receive data from sensors 112. The data may include a request to analyze the data. As stated above, machine learning module 116-1 at beverage system 110 may be unable to identify an action above a threshold confidence level or may determine that a repair action failed to fix an error. Therefore, beverage system 110 may send the sensor data, and repair action if applicable, to cloud server 130 for analysis.

Machine learning module 116-2 at cloud server 130 may analyze the data received from beverage system 110. For example, machine learning module 116-2 may apply a machine learning model to the received data to diagnose the sensor data and generate an action for beverage system 110 to perform.

In some embodiments, machine learning module 116-2 may update its machine learning model by retraining. Retraining may use data received from beverage system 110. For example, machine learning module 116-2 may use sensor data and repair actions, successful or not, to train the machine learning model to identify sensor data and effective actions to address the sensor data. Once trained, cloud server 130 may send the updated machine learning model to beverage systems 110. In some embodiments, cloud server 130 may send the updated model to all beverage systems 110 on network 120.

Since cloud server 130 may be in communication with hundreds, thousands, or millions of beverage systems 110, cloud server 130 may have access to millions or billions of sensor data points. This quantity of data allows cloud server 130 to train a precise and accurate machine learning model capable of identifying, fixing, and preventing a multitude of errors at beverage systems 110. Cloud server 130 may then send the trained machine learning model to beverage system 110, allowing beverage system 110 to utilize the latest, accurate data to diagnose sensor data. The more capability beverage system 110 has to analyze sensor data and address it, the less congestion and latency network 120 will experience. As a result, communication over network 120 may be reserved for instances where beverage system 110 is unable to correct an error state. Additionally, beverage system 110 will operate at peak efficiency for longer since it will be able to diagnose, repair, and prevent errors more effectively.

Although cloud server 130 may be a centralized or global system, it may be configured to handle nuances based on the distribution of beverage systems 110. For example, beverage systems 110 may be distributed across various countries, states, counties, cities, and towns. Beverage systems 110 may also be distributed across various climates. For example, a state may include an arid region and a rainforest region. The climate in each of these regions may have very different effects on beverage system 110. For example, the arid region may have high temperatures causing beverage system 110 to easily overheat. In contrast, the rainforest region may be extremely humid causing rust or electrical issues at beverage system 110. Here, each beverage system 110 may include a GPS that reports location information, along with sensor 112 data to cloud server 130. Here, cloud server 130 and beverage system 110, may reference the GPS location data to further learn patterns in the sensor data and effective repair actions for the location. In turn, this will make the beverage systems 110 in each region more resilient since actions in response to the sensor data is tailored to the local environment.

Client device 140 may be any entity attempting to communicate with beverage system 110 and/or cloud server 130. Although a single client device 140 is depicted, beverage equipment environment 100 may include multiple client devices 140. Client devices 140 may be deployed throughout a local, regional, national, and/or global network. Client device 140 may be a computer system such as computer system 1300 described with reference to FIG. 13. Client device 110 may be a client system such as a desktop workstation, laptop or notebook computer, netbook, tablet, smart phone, and/or other computing device that may be using an enterprise computing system.

Client device 140 includes communication interface 120-3, and display device 142. Communication device 120-3 may be configured to communicate with beverage system 110 and cloud server 130 via network 120. Communication device 120-3 may comprise any suitable network interface capable of transmitting and receiving data, such as, for example a modem, an Ethernet card, a communications port, or the like. Communication device 120-3 may be able to transmit data using any wireless transmission standard such as, for example, Wi-Fi, Bluetooth, cellular, or any other suitable wireless transmission. Display device 142 may be configured to display information at client device 140. Display device 142 may be configured to receive interactions from a user. An interaction may be a click, a button press, a swipe, etc.

Client device 140 may be associated with beverage system 110. For example, client device 140 may be linked to beverage system 110 by scanning a barcode or registering an identifier associated with beverage system 110. As another example, client device 140 may establish the link by accessing an online portal and inputting beverage system's 110 identifier. As a result, client device 140 may receive alerts or notifications from beverage system 110. For example, if beverage system 110 encounters an error or requires preventative maintenance, beverage system 110 may send a notification or alert to subscriber client devices 140 (e.g., linked client devices 140). As stated above, machine learning module 116 may determine that an external entity is needed to address an issue at beverage system 110. Here, client device 140 may be associated with the external entity and receive an alert regarding the issue. In some embodiments, client device 140 may be associated with a part supplier (e.g., a store) that has access to a new or replacement part needed by beverage system 110. Beverage system 110 may additionally send a notification or alert to client device 140 when an error has been fixed, or when preventative maintenance has been performed. In some embodiments, as part of its optimization function, machine learning module 116 may optimize recommendations for replacement parts and service providers based on cost, efficiency, speed, logistics, and environmental impact preferences. For example, machine learning module 116 may account for carbon emissions when predicting reparative actions, such as ordering replacement parts. Here, machine learning module 116 may predict two solutions with equal confidence of fixing beverage system 110, but may rank a first solution associated with lower carbon emissions higher than a second solution with higher carbon emissions.

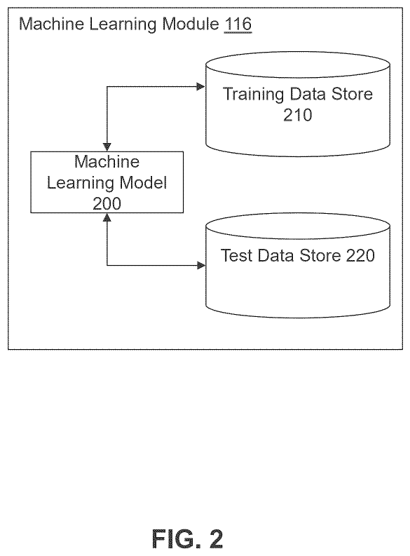

FIG. 2 depicts a block diagram of a machine learning module 116, according to some embodiments. Machine learning module 116 includes machine learning model 200, training data store 210, and test data store 220. Although a single machine learning model 200 is depicted, machine learning module 116 may include more than one machine learning model 200. Although training data store 210 and test data store 220 are depicted as separate entities, they may reside within the same memory storage device. Additionally, training data store 210 and test data store 220 may be equal (e.g., include the same data), disjoint (e.g., include distinct data in each store), or overlapping (e.g., some data is present in both stores).

Machine learning model 200 may be any machine learning model to analyze data from sensor 112. For example, machine learning model 200 may be a perceptron, support vector machine, neural network, convolutional neural network, generative adversarial network, large language model, transformer model, or recurrent neural network. Machine learning model 200 may incorporate any combination of models. This may be beneficial because different models may be optimized for different tasks. For example, machine learning model 200 may include a convolutional neural network to analyze image or video data from camera sensor 112-1, and a feed forward neural network to analyze data from humidity sensor 112-2.

Machine learning model 200 may be configured to input sensor data and predict a condition of beverage system 110 based on the sensor data. Machine learning model 200 may predict the condition by performing pattern recognition. Machine learning model 200 may include an internal representation for each type of sensor data it is configured to analyze. The internal representations may be stored as numerical vectors or n-dimensional matrices, corresponding to features machine learning model 200 is configured to learn. In this application, the features may be sensor data values and how they relate to aspects of beverage system's 110 operation. In some embodiments, sensor data may be categorized including normal values, error values, or values indicating preventative maintenance is required. For example, machine learning model 200 may include a representation for temperature. This representation may include temperature values associated with normal operation, error state(s), and state(s) requiring preventative maintenance.

When sensor data is received, data from each sensor may be compared to machine learning model's 200 internal representation of that sensor data. Based on the comparison, machine learning model 200 may predict a condition of beverage system 110. For example, machine learning model 200 may receive temperature, humidity, noise, vibration, and magnetism data. Machine learning model 200 may analyze the sensor data types and their respective values to predict whether they indicate a condition (e.g., normal, error, or preventative maintenance) at beverage system 110.

For example, the humidity, noise, vibration, and magnetism data may all include normal readings, but the temperature may be at a level correlated with a faulty fan. Thus, machine leaning model 200 may predict that a fan at beverage system 110 has failed. Machine learning model 200 may be further configured to leverage a combination of sensor data to make a prediction. For example, the temperature and humidity data may be normal, but the noise, vibration, and magnetism data may all indicate an error. Machine learning model 200 may be trained to learn that this combination of sensor data is most likely correlated with a motor error at beverage system 110.

The predicted condition may vary based on the specific values of the sensor data. Using the example above, a first combination of noise, vibration, and magnetism data may indicate a motor error whereas a second combination of noise, vibration, and magnetism data may indicate an electrical system error.

Machine learning model 200 may generate multiple predicted conditions for a given set of sensor data. Each predicted condition may be assigned a probability associated with machine learning model's 200 confidence that the predicted condition is correct. For example, given a set of temperature, humidity, noise, vibration, and magnetism data, machine learning model 200 may predict that: (1) a motor has failed; (2) an electrical system has failed; and (3) beverage system 110 is operating normally with respective confidence scores: (1) 80%; (2) 15%; and (3) 5%.

Machine learning model 200 may be further configured to predict actions, based on the predicted condition. If machine learning model 200 predicts that beverage system 110 is operating normally and does not require preventative maintenance, machine learning model 200 may predict that no action is needed. If machine learning model 200 predicts beverage system 110 is encountering an error and/or requires preventative maintenance, machine learning model 200 may predict an action to repair the error and/or perform the maintenance. Similar to the conditions, machine learning model 200 may predict multiple actions for a given set of sensor data. The actions may be predicted according to a probability distribution. Each probability may correspond to machine learning model's 200 confidence that the action is correct given the predicted condition.

Machine learning model 200 may use training data store 210 and test data store 220 for training and testing purposes. Training data store 210 may be implemented using a memory storage device. Training data store 210 may include data used to train machine learning model 200. Training data store 210 may include various types of data. For example, training data store 210 may include sensor data, actions taken in response to the sensor data, and results. The sensor data may be labelled to identify which sensor 112 the data came from. The sensor data may additionally be labeled with whether the data includes a condition, such as an error. For example, sensor data may be labeled as normal, an error, or requiring preventative maintenance. The result may indicate whether the actions addressed the sensor data successfully or not. The result may be a binary value such as “true/false,” or “0/1.” In some embodiments, the result may be a value such as a percentage indicating the effectiveness of the action. For example, data from sensors 112 may indicate that the temperature is too high within beverage system 110. As a result, beverage system 110 may actuate a fan to cool the temperature. However, the fan may have only brought the temperature halfway towards the goal temperature. Here, the result may indicate that actuating the fan was 50% effective. This level of granularity is beneficial so that machine learning model 200 learns that multiple actions may be necessary to fix an error. Using the example above, machine learning model 200 may be updated to learn that the executing the fan and disabling a lighting source successfully cooled beverage system 110.

Machine learning model 200 may train on data at training data store 210. Machine learning model 200 may train to accomplish two goals. First, machine learning model 200 may train to identify a condition within the sensor data. In some embodiments, the condition may indicate an error at beverage system 110. The condition may also indicate that preventative maintenance is required. At this stage, machine learning model 200 may input sensor data and generate an output. The output may be a single value corresponding to a condition in the sensor data. In some embodiments, the output may be a probability distribution over one or more conditions. For example, machine learning model 200 may detect four conditions in the sensor data, and assign them each a probability score. In some embodiments, the output may indicate that multiple conditions exist simultaneously. For example, beverage system 110 may be overheating and may be experiencing power failure. In this instance, the output may be two values indicating the overheating and power failure. The output may also be two separate probability distributions, each one based on the conditions that machine learning model 200 has detected. The output may be compared to a label. The label may be the actual condition present in the sensor data. An error may be calculated based on the difference between the output and the label. The calculated error may be used to update machine learning model 200. In some embodiments, machine learning model 200 may be updated using backpropagation.

Second, machine learning model 200 may be trained to predict actions addressing the identified condition(s). Here, machine learning model 200 may input sensor data and output an action. The action may be based on a condition identified within the sensor data. In some embodiments, machine learning model 200 may be given the condition within the sensor data. This may be advantageous to prioritize resources towards improving machine learning model's 200 ability to predict correct actions. In some embodiments, machine learning model 200 may not be given the condition. Here, machine learning model 200 may predict the condition and the action. The output action may be a single value (e.g., a single action to perform). In some embodiments, the output may be a probability distribution over a set of actions. The probability may correspond to machine learning model's 200 confidence in each action. The output actions may be compared to a label for the sensor data. The label may be the correct action to address the condition within the sensor data. An error between the output action and label may be calculated and used to update machine learning model 200.

Machine learning model 200 may use test data store 220 for testing and validation purposes. For example, once machine learning model 200 trains on training data store 210, it may use the data at test data store 220 to evaluate its performance. Machine learning model 200 may use test data store 220 by generating predictions for data at test data store 220. Each prediction may be compared against a ground truth label in order to determine machine learning model's 200 accuracy. Testing may involve the same steps as the training process described above, except that machine learning model 200 is not updated based on the results.

Using machine learning model 200 to diagnose beverage system 110 and predict accompanying actions has several benefits. First, it allows accurate diagnosis and repair of beverage system 110 to be automatically performed, without manual intervention. Performing this self-healing process at the network edge will result in faster resolutions and increased operation time because the actions are performed locally. Second, data generated by sensors 112 and used in diagnosis and repair may be further used to improve machine learning model 200. Thus, each time machine learning model 200 generates predictions and receives results, it may be retrained to improve its performance and efficiency. This ability not only benefits the local beverage system 110, but can be sent to other beverage systems 110 so that they may also be improved from the data, diagnosis, and actions taken. Third, beverage system 110 can use machine learning model's 200 predictions to send alerts and notifications to other entities on network 120, apprising them of beverage system's 110 status.

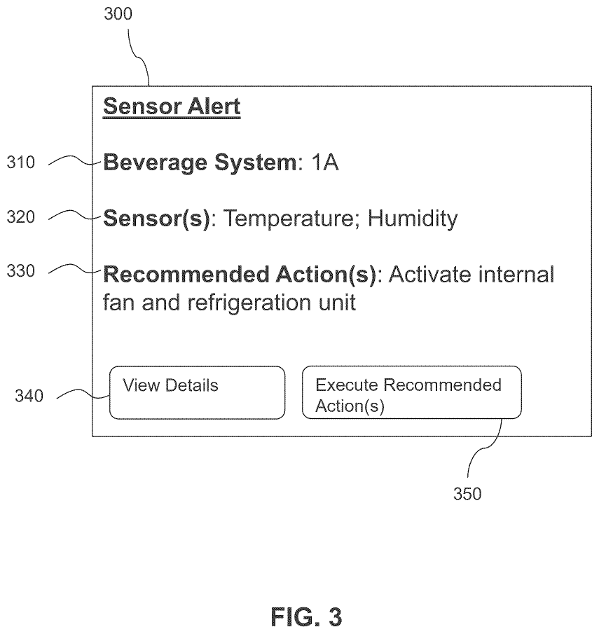

FIG. 3 depicts an exemplary interface 300 for a sensor alert, according to some embodiments. Interface 300 may be shown via display engine 142 on client device 140 when it receives an alert. The alert may be generated by machine learning module 116-1 at beverage system 110. Interface 300 may include details regarding the alert. For example, interface 300 may include a beverage system identifier 310. Beverage system identifier 310 may be a field to identify beverage system 110. Sensors 320 may list data types from sensors 112 that caused the alert to be generated. For example, anomalies may have been detected in data from thermometer 112-6 and humidity sensor 112-2. Therefore, sensors 320 may list humidity and temperature. Recommended actions 330 may list the actions generated by machine learning module 116. In some embodiments, recommended actions 330 may include recommendations from machine learning module 116-1 at beverage system 110, or recommendations from machine learning module 116-2 at cloud server 130, or both. View details 340 may be a button that when interacted with, launches a new interface to view the sensor details. Execute recommended action 350 may be a button that when interacted with, sends a message to beverage system 110 to perform the listed recommended action. The message may only include the actions listed at recommended actions 330. Maintenance device 118 may perform the action at beverage system 110.

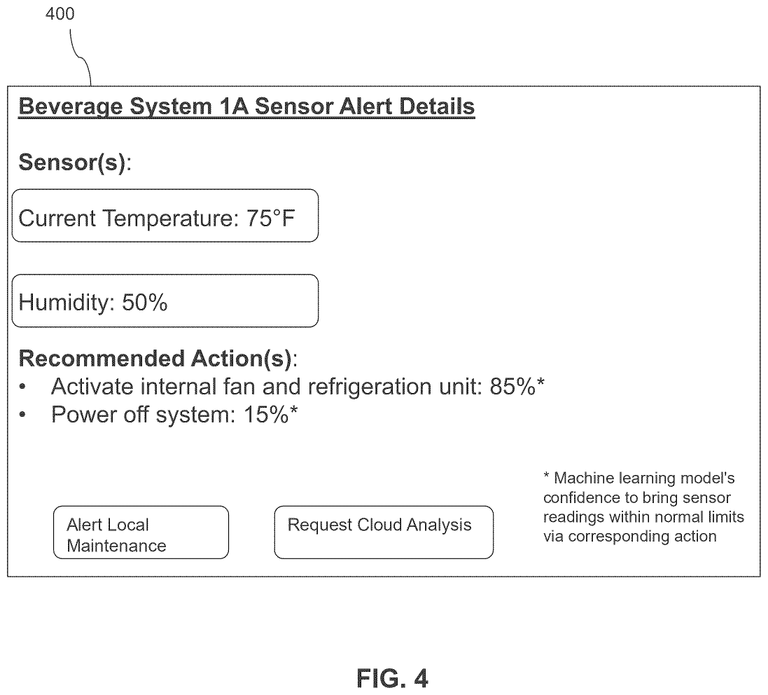

FIG. 4 depicts an exemplary interface 400 for sensor alert details, according to some embodiments. Interface 400 may be displayed via display device 142 at client device 140. Interface 400 may display additional details of the alert. The alert may be generated by machine learning module 116-1 at beverage system 110. Interface 400 may include the sensor data readings that triggered the alert. For example, the anomalous temperature and humidity values may be displayed at interface 400. Interface 400 may include alert local maintenance 410 and request cloud analysis 420. Alert local maintenance 410 may be a button that when pressed, sends a message to request a maintenance entity to address a condition at beverage system 110. For example, the message may include a request to fix an error at beverage system 110. In some embodiments, the message may be sent directly to a maintenance entity from client device 140. In some embodiments, the message may first go to cloud server 130, and then to the maintenance entity. Request cloud analysis 420 may be a button that when interacted with, sends a message to cloud server 130. The message may include the sensor data, the alert, and a request for cloud server 130 to analyze the sensor data to generate a recommended action.

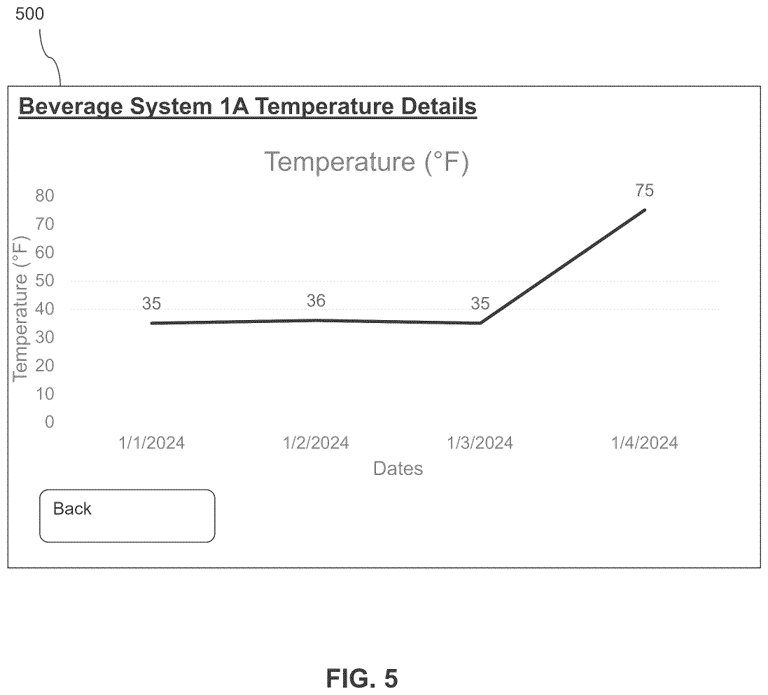

FIG. 5 depicts an exemplary interface 500 for sensor reading details, according to some embodiments. Interface 500 may be displayed to show details regarding a sensor reading. Interface 500 may display historical information regarding sensor 112. For example, interface 500 may display historical temperatures reported by thermometer 112-6. This may be beneficial to view sensor's 112 usual output and determine whether an error or other condition associated with beverage system 110 or its environment exists. In some embodiments, interface 500 may be updated in real-time with updated sensor reading details. For example, beverage system 110 may send real-time sensor values to client device 140. Interface 500 may update according to the new sensor values.

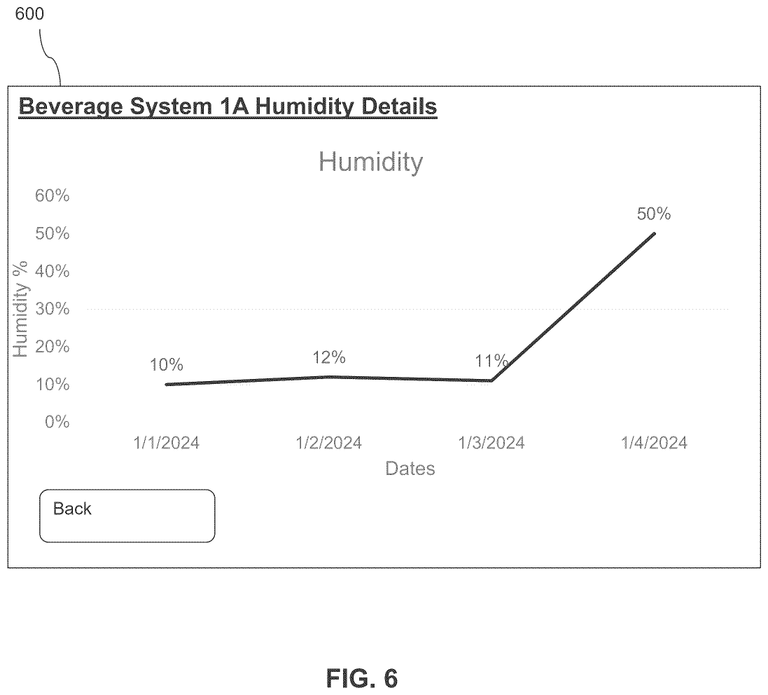

FIG. 6 depicts an exemplary interface 600 for sensor reading details, according to some embodiments. Interface 600 depicts details regarding humidity sensor 112-2. Interface 600 includes a graph showing historical humidity values detected at beverage system 110. Similar to interface 500, this may be useful to view normal values for sensor 112 and may be used to determine whether an anomaly is occurring at or near beverage system 110. Similar to interface 500, interface 600 may also be updated in real-time with new sensor values.

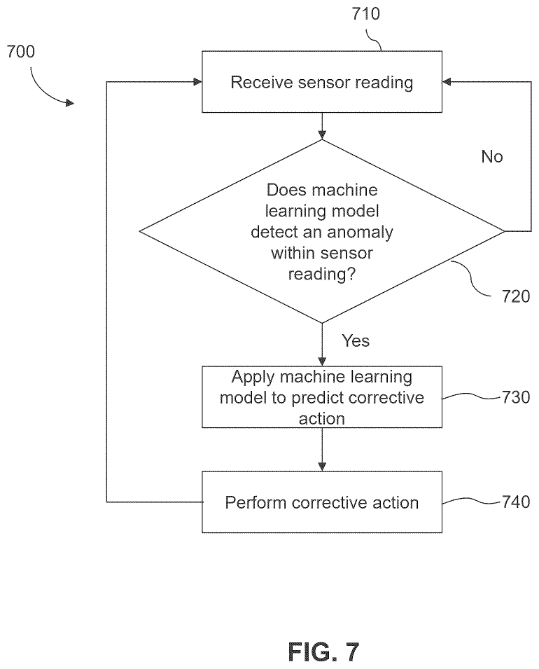

FIG. 7 depicts a flowchart illustrating a method 700 for using sensor data to take corrective action, according to some embodiments. Method 700 shall be described with reference to FIG. 1, however, method 700 is not limited to that example embodiment.

In an embodiment, beverage system 110 and/or cloud server 130 may utilize method 700 to analyze sensor data. If the sensor data indicates an anomaly is present, corrective action may be taken. The foregoing description will describe an embodiment of the execution of method 700 with respect to beverage system 110 and/or cloud server 130. While method 700 is described with reference to beverage system 110, method 700 may be executed on any computing device, such as, for example, the computer system described with reference to FIG. 13 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 7.

At 710, beverage system 110 receives a sensor reading. The sensor reading may be generated by sensor 112. The sensor reading may include information regarding the state of beverage system 110 and/or its environment. The sensor reading may be received by sensor aggregator device 114. In some embodiments, sensor readings from multiple sensors 112 may be received.

At 720, beverage system 110 applies a machine learning model to predict whether the sensor reading includes an anomaly. Beverage system 110 may use machine learning module 116-1 to make the prediction. This may involve inputting the sensor reading to a machine learning model. An anomaly may include an error and/or whether preventative maintenance is required. If no anomaly is detected, method 700 returns to 710. If an anomaly is detected, method 700 continues to 730.

At 730, beverage system 110 applies a machine learning model to predict a corrective action. Beverage system 110 may use machine learning module 116-1 to generate the corrective action. The corrective action may include executing a repair at beverage system 110. In some embodiments, the corrective action may include contacting an external entity. Here, machine learning module 116-1 may generate an alert or notification to send to the external entity. The machine learning model may predict multiple corrective actions, each assigned a confidence score.

At 740, beverage system 110 performs the corrective action. Beverage system 110 may perform the corrective action with the highest confidence score. If the corrective action is a local repair, beverage system 110 may use maintenance device 118 to perform the action. For example, beverage system 110 may use maintenance device 118 to actuate a lighting system or perform a power reset. If the corrective action requires an external entity, beverage system 110 may transmit an alert or notification to the external entity.

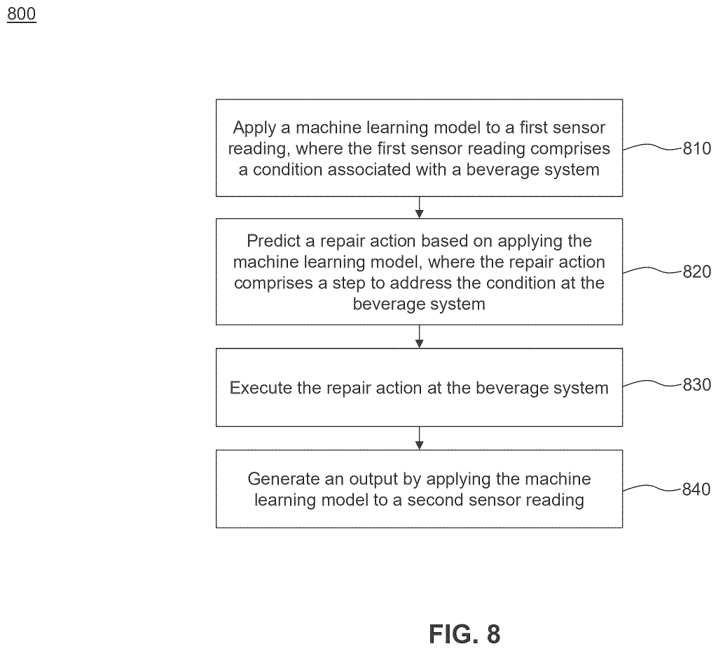

FIG. 8 depicts a flowchart illustrating a method 800 for proactive equipment machine health monitoring and self-healing using sensors and AI, according to some embodiments. Method 800 shall be described with reference to FIG. 1, however, method 800 is not limited to that example embodiment.

In an embodiment, beverage system 110 may utilize method 800 to detect a condition at a beverage system and execute a repair action. The foregoing description will describe an embodiment of the execution of method 800 with respect to beverage system 110. While method 800 is described with reference to beverage system 110, method 800 may be executed on any computing device, such as, for example, the computer system described with reference to FIG. 13 and/or processing logic that may comprise hardware (e.g., circuitry, dedicated logic, programmable logic, microcode, etc.), software (e.g., instructions executing on a processing device), or a combination thereof. In some embodiments, method 800 may be executed on cloud server 130.

It is to be appreciated that not all steps may be needed to perform the disclosure provided herein. Further, some of the steps may be performed simultaneously, or in a different order than shown in FIG. 8.

At 810, beverage system 110 applies a machine learning model to a first sensor reading, where the first sensor reading comprises a condition associated with beverage system 110. The first sensor reading may originate from sensor 112 such as camera sensor 112-1 or humidity sensor 112-2. The first sensor reading may include data from multiple sensors 112. The condition may include information regarding the state of beverage system 110 and/or its environment. In some embodiments, the condition may indicate that beverage system 110 is operating normally, is in error state (e.g., not functioning properly), or requires preventative maintenance. In some embodiments, beverage system 110 may apply machine learning model 200 at machine learning module 116-1. Machine learning model 200 may be configured to analyze the condition. For example, machine learning model 200 may detect that the condition indicates that the beverage system 110 has encountered an error state. In some embodiments, machine learning model 200 may detect that beverage system 110 needs preventative maintenance. Machine learning model 200 may generate multiple outputs. For example, the output may indicate that part of beverage system 110 has encountered an error (e.g., the cooling system), part of beverage system 110 requires preventative maintenance (e.g., a fluid conduit), and the remainder of beverage system 110 is functioning normally.

At 820, beverage system 110 predicts a repair action based on applying the machine learning model, where the repair action comprises a step to address the condition at beverage system 110. In some embodiments, the repair action may include multiple actions where each action is assigned a confidence score or probability indicating the likelihood of addressing the condition. The repair action may be generated by the machine learning model (e.g., machine learning model 200).

At 830, beverage system 110 executes the repair action. In some embodiments, beverage system 110 may use maintenance device 118 to execute the repair action. For example, the repair action may include reducing the temperature at beverage system 110. Beverage system 110 may use maintenance device 118 to actuate a fan and reduce the temperature. In an embodiment where the repair action includes multiple actions, each assigned a confidence score, beverage system 110 may execute the repair action with the greatest confidence score. In some embodiments, the repair action may include alerting or notifying a third party of the condition. For example, beverage system 110 may be encountering an error that cannot be fixed locally. Here, the repair action may include alerting a repair company to assist in fixing beverage system 110. In some embodiments, the repair action may require new or additional parts for beverage system 110. Machine learning module 116-1 may generate an order form to acquire the new or additional parts. In response, beverage system 110 may place the order for new or additional parts so that they may be installed. The parts may be shipped directly to the location where beverage system 110 is located. In some embodiments, the parts may be shipped to a party capable of installing them at beverage system 110.

At 840, beverage system 110 generates an output by applying the machine learning model to a second sensor reading. The second reading may originate from the same sensor(s) 112 as the first sensor reading. For example, the first and second sensor reading may both generate from thermometer 112-6. In some embodiments, beverage system 110 may apply the machine learning model at machine learning module 116-1. The output may indicate whether the repair action addressed the condition. For example, if the first sensor reading indicated beverage system 110 was encountering an error and the repair action fixed the error, beverage system 110 may detect, via the machine learning model, that the error is no longer occurring. In some embodiments, the repair action may not have corrected the error and beverage system 110 may detect that the error is still occurring.

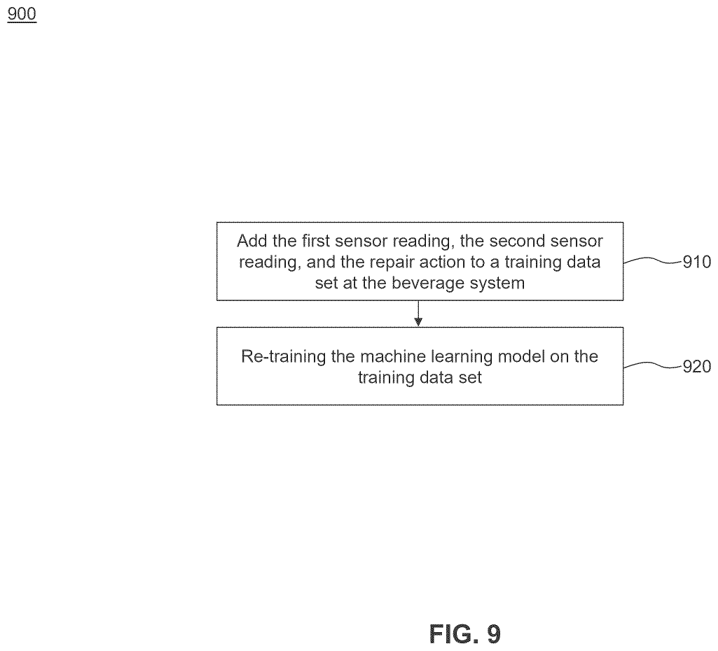

FIG. 9 is a flowchart illustrating an example method 900 for locally retraining a machine learning model, according to some embodiments. Method 900 shall be described with reference to FIG. 1, however, method 900 is not limited to that example embodiment.

In an embodiment, beverage system 110 may utilize method 900 to retrain a machine learning model to improve its performance. The foregoing description will describe an embodiment of the execution of method 900 with respect to beverage system 110. While method 900 is described with reference to beverage system 110, method 900 may be executed on any computing device, such as, for example, the computer system described with reference to FIG. 13 and/or processing logic that may comprise hardware (e.g., circuitry, dedicated logic, programmable logic, microcode, etc.), software (e.g., instructions executing on a processing device), or a combination thereof. In some embodiments, method 900 may be executed on cloud server 130.

It is to be appreciated that not all steps may be needed to perform the disclosure provided herein. Further, some of the steps may be performed simultaneously, or in a different order than shown in FIG. 9.

At 910, beverage system 110 adds the first sensor reading, the second sensor reading, and the repair action to a training data set. The training data set may be located at machine learning module 116-1 at beverage system 110. The training data set may be stored at training data store 210, test data store 220, or a combination of both. The first sensor reading and the repair action may be grouped together at the training data set. In some embodiments, the second sensor reading may be converted into a label for the example (e.g., the first sensor reading and the repair action). If the second sensor reading indicates that the repair action fixed an error at beverage system 110, a label may be added to the example. The label may be “fixed,” “correct action,” “1,” or any other indicator. If the second sensor reading indicates that the repair action did not fix an error at beverage system, the label may be “did not fix,” “incorrect action,” “0,” or any other indicator.

At 920, beverage system 110 retrains the machine learning model on the training data set. The machine learning model may be machine learning model 200 at machine learning module 116. Retraining may involve machine learning model 200 iterating over each example at training data store 210. For each sensor data example, the machine learning model predicts whether the sensor data indicates beverage system 110 is encountering an error or requires preventative maintenance, and if so, generates a repair action. The second sensor reading may be used as a label for the effectiveness of the repair action.

For example, if the first sensor reading indicated an error and the second sensor reading indicates the repair action fixed the error, then the machine learning model should predict the repair action after analyzing the first sensor reading. If the first sensor reading indicated that beverage system 110 is operating within normal limits, the machine learning model should predict that no repairs are needed. If the model fails to predict an error in the first sensor reading or fails to identify the correct repair action, an error may be calculated and used to update the machine learning model.

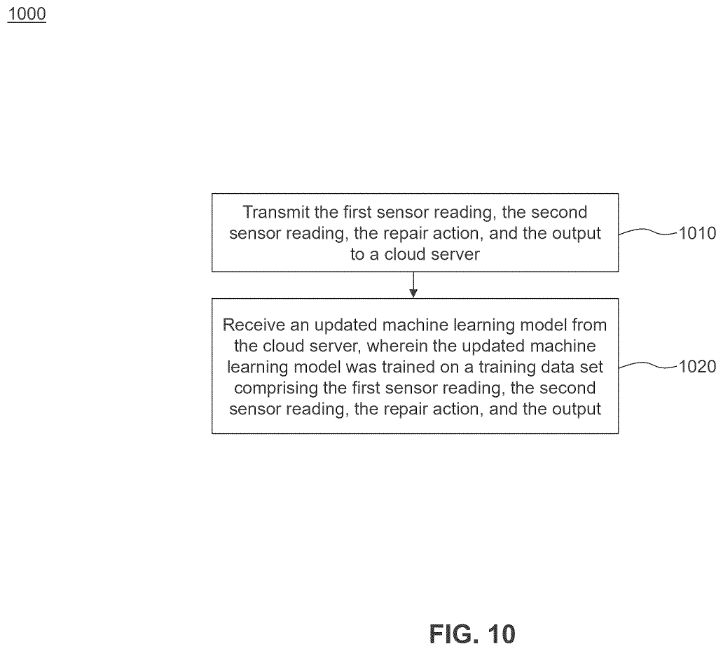

FIG. 10 is a flowchart illustrating an example method 1000 for remotely retraining a machine learning model, according to some embodiments. Method 1000 shall be described with reference to FIG. 1, however, method 1000 is not limited to that example embodiment.

In an embodiment, beverage system 110 may utilize method 1000 to receive an updated machine learning model from cloud server 130. The foregoing description will describe an embodiment of the execution of method 1000 with respect to beverage system 110. While method 1000 is described with reference to beverage system 110, method 1000 may be executed on any computing device, such as, for example, the computer system described with reference to FIG. 13 and/or processing logic that may comprise hardware (e.g., circuitry, dedicated logic, programmable logic, microcode, etc.), software (e.g., instructions executing on a processing device), or a combination thereof. In some embodiments, method 1000 may be executed on cloud server 130.

It is to be appreciated that not all steps may be needed to perform the disclosure provided herein. Further, some of the steps may be performed simultaneously, or in a different order than shown in FIG. 10.

At 1010, beverage system 110 transmits the first sensor reading, the second sensor reading, the repair action, and the output to a cloud server. The cloud server may be cloud server 130. The transmission may occur at communication device 120-1 via network 120. In some embodiments, the transmission may occur if the repair action failed to fix an error associated with beverage system 110. In some embodiments, beverage system 110 may transmit the information in order to update a machine learning model at cloud server 130.

At 1020, beverage system 110 receives an updated machine learning model from the cloud server, where the updated machine learning model was trained on a training data set comprising the first sensor reading, the second sensor reading, the repair action, and the result. Beverage system 110 may receive the updated machine learning model from cloud server 130. The updated machine learning model may replace or update machine learning model 200 at machine learning module 116-1.

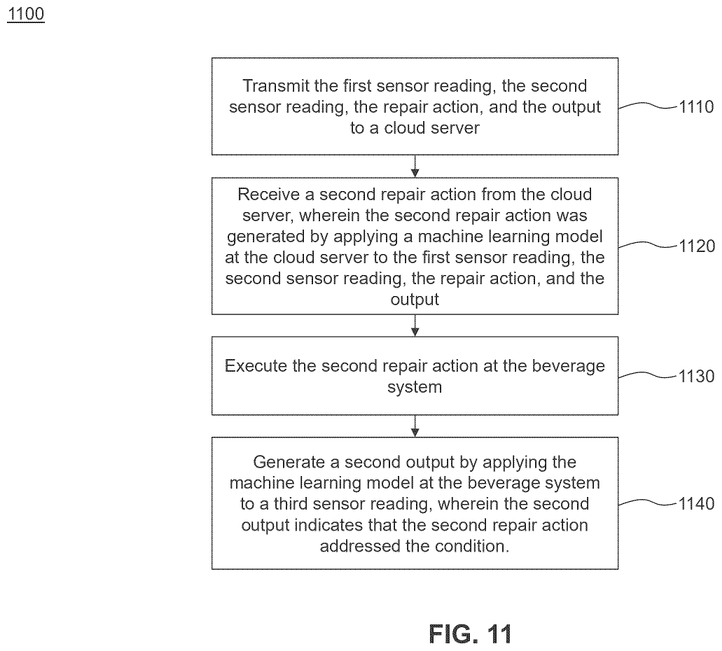

FIG. 11 is a flowchart illustrating an example method 1100 for receiving a repair action from a cloud server, according to some embodiments. Method 1100 shall be described with reference to FIG. 1, however, method 1100 is not limited to that example embodiment.

In an embodiment, beverage system 110 may utilize method 1100 to leverage cloud server 130 to receive a recommended repair action. Method 1100 may be useful in a situation where the cloud server has a different machine learning model that can be leveraged to address a condition at beverage system 110. The foregoing description will describe an embodiment of the execution of method 1100 with respect to beverage system 110. While method 1100 is described with reference to beverage system 110, method 1100 may be executed on any computing device, such as, for example, the computer system described with reference to FIG. 13 and/or processing logic that may comprise hardware (e.g., circuitry, dedicated logic, programmable logic, microcode, etc.), software (e.g., instructions executing on a processing device), or a combination thereof. In some embodiments, method 1100 may be executed on cloud server 130.

It is to be appreciated that not all steps may be needed to perform the disclosure provided herein. Further, some of the steps may be performed simultaneously, or in a different order than shown in FIG. 11.

At 1110, beverage system 110 transmits the first sensor reading, the second sensor reading, the repair action, and the output to a cloud server. In some embodiments, the cloud server may be cloud server 130. The transmission may occur at communication device 120-1 via network 120. In some embodiments, the output may indicate that the repair action failed to fix an error at beverage system 110.

At 1120, beverage system 110 receives a second repair action from the cloud server, wherein the second repair action was generated by applying a machine learning model at the cloud server to the first sensor reading, the second sensor reading, the repair action, and the output. For example, cloud server 130 may use machine learning module 200 at machine learning module 116-2 to analyze the sensor readings and generate the second repair action. Cloud server 130 may generate a different repair action than beverage system 110 because cloud server 130 may have an updated machine learning model. As stated above, cloud server 130 may be connected to thousands or millions of beverage systems 110. As a result, cloud server 130 may update its machine learning model more frequently than beverage system 110.

At 1130, beverage system 110 executes the second repair action at the beverage system. Beverage system 110 may use maintenance device 118 to execute the repair action.

At 1140, beverage system 110 generates a second output by applying the machine learning model at the beverage system to a third sensor reading, where the second output indicates that the second repair action addressed the condition. The third sensor reading may be generated by the same sensor 112 that generated the first and second sensor readings. For example, humidity sensor 112-2 may have generated the first, second, and third sensor readings.

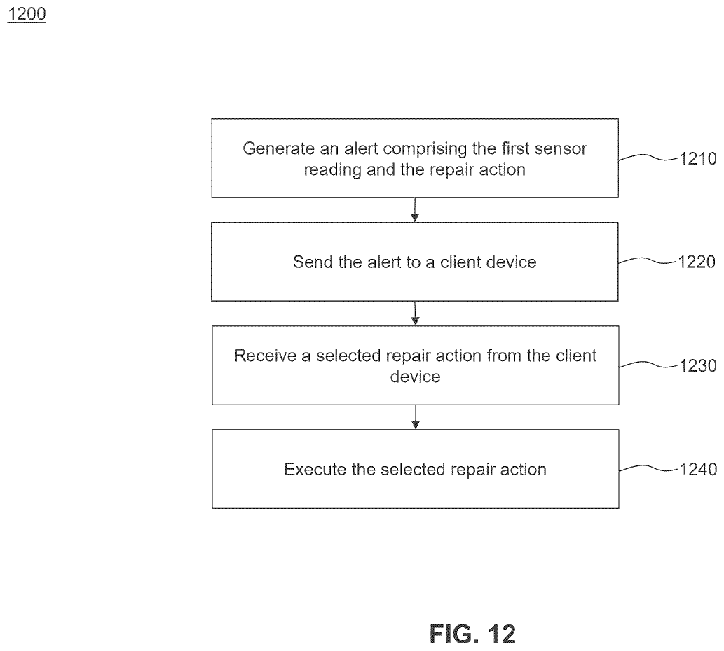

FIG. 12 is a flowchart illustrating an example method 1200 for sending an alert, according to some embodiments. Method 1200 shall be described with reference to FIG. 1, however, method 1200 is not limited to that example embodiment.

In an embodiment, beverage system 110 may utilize method 1200 to alert or notify a client device of a condition at beverage system 110. In response, beverage system 110 may receive a selection of a repair action to take. The foregoing description will describe an embodiment of the execution of method 1200 with respect to beverage system 110. While method 1200 is described with reference to beverage system 110, method 1200 may be executed on any computing device, such as, for example, the computer system described with reference to FIG. 13 and/or processing logic that may comprise hardware (e.g., circuitry, dedicated logic, programmable logic, microcode, etc.), software (e.g., instructions executing on a processing device), or a combination thereof. In some embodiments, method 1200 may be executed on cloud server 130.

It is to be appreciated that not all steps may be needed to perform the disclosure provided herein. Further, some of the steps may be performed simultaneously, or in a different order than shown in FIG. 12.

At 1210, beverage system 110 generates an alert comprising the first sensor reading and the repair action. The first sensor reading may be generated by sensor 112. The repair action may be generated by machine learning model 200 analyzing the first sensor reading. Beverage system 110 may generate the alert in response to the machine learning model predicting that the first sensor reading comprises an error that cannot be fixed locally by beverage system 110. For example, the first sensor reading may indicate that beverage system needs a new part installed. In some embodiments, the alert may be generated if a repair action has a corresponding confidence score below a predefined threshold. The alert may include the current sensor reading and historical data from sensor 112. The repair action may include one or more actions. Each repair action may have an assigned confidence score.

At 1220, beverage system 110 sends the alert to a client device. The client device may be client device 140. Client device 140 may be configured to populate the alert on display device 142. This may be advantageous to immediately notify a user associated with client device 140. This real-time notification will improve beverage system 110 by repairing an error or performing preventative maintenance faster, thereby extending the life of beverage system 110 and improving its uptime. The alert may be sent from communication device 120-1 via network 120.

At 1230, beverage system 110 receives a selected repair action from the client device. The selected repair action may be received at communication device 120-1 via network 120. In some embodiments, the selected repair action may be a single action (e.g., turn on the cooling system). In some embodiments, the selected repair actions may include multiple actions. For example, the selected repair action may include turning on the cooling fan and disabling a lighting system. The selected repair action may include an order to execute actions. For example, the selected repair action may indicate to first turn on the cooling fan, and then disable the lighting system. This level of granularity: (1) improves beverage system 110 by making it more likely that any errors will be fixed; and (2) reduces network latency or bottlenecks since all the information only needs to be communicated once. Selecting multiple actions alleviates the need for generating repeat alerts if selected actions fail to correct an error.

At 1240, beverage system 110 executes the selected repair action. In some embodiments, beverage system 110 may use maintenance device 118 to execute the repair action. For example, the repair action may include reducing the temperature at beverage system 110. Beverage system 110 may use maintenance device 118 to actuate a fan and reduce the temperature.

Various embodiments may be implemented, for example, using one or more well-known computer systems, such as computer system 1300 shown in FIG. 13. One or more computer systems 1300 may be used, for example, to implement any of the embodiments discussed herein, as well as combinations and sub-combinations thereof.

Computer system 1300 may include one or more processors (also called central processing units, or CPUs), such as a processor 1304. Processor 1304 may be connected to a communication infrastructure or bus 1306.

Computer system 1300 may also include user input/output device(s) 1303, such as monitors, keyboards, pointing devices, etc., which may communicate with communication infrastructure 1306 through user input/output interface(s) 1302.

One or more of processors 1304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1300 may also include a main or primary memory 1308, such as random access memory (RAM). Main memory 1308 may include one or more levels of cache. Main memory 1308 may have stored therein control logic (i.e., computer software) and/or data.

Computer system 1300 may also include one or more secondary storage devices or memory 1310. Secondary memory 1310 may include, for example, a hard disk drive 1312 and/or a removable storage device or drive 1314. Removable storage drive 1314 may be a floppy disk drive, a magnetic tape drive, a compact disk drive, an optical storage device, tape backup device, and/or any other storage device/drive.

Removable storage drive 1314 may interact with a removable storage unit 1318. Removable storage unit 1318 may include a computer usable or readable storage device having stored thereon computer software (control logic) and/or data. Removable storage unit 1318 may be a floppy disk, magnetic tape, compact disk, DVD, optical storage disk, and/any other computer data storage device. Removable storage drive 1314 may read from and/or write to removable storage unit 1318.

Secondary memory 1310 may include other means, devices, components, instrumentalities or other approaches for allowing computer programs and/or other instructions and/or data to be accessed by computer system 1300. Such means, devices, components, instrumentalities or other approaches may include, for example, a removable storage unit 1322 and an interface 1320. Examples of the removable storage unit 1322 and the interface 1320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1300 may further include a communication or network interface 1324. Communication interface 1324 may enable computer system 1300 to communicate and interact with any combination of external devices, external networks, external entities, etc. (individually and collectively referenced by reference number 1328). For example, communication interface 1324 may allow computer system 1300 to communicate with external or remote devices 1328 over communications path 1326, which may be wired and/or wireless (or a combination thereof), and which may include any combination of LANs, WANs, the Internet, etc. Control logic and/or data may be transmitted to and from computer system 1300 via communication path 1326.

Computer system 1300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1300, main memory 1308, secondary memory 1310, and removable storage units 1318 and 1322, as well as tangible articles of manufacture embodying any combination of the foregoing. Such control logic, when executed by one or more data processing devices (such as computer system 1300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 13. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
applying a machine learning model to a first sensor reading, wherein the first sensor reading comprises a condition associated with a beverage system;
predicting a repair action based on applying the machine learning model, wherein the repair action comprises a step to address the condition at the beverage system;
executing the repair action at the beverage system; and
generating an output by applying the machine learning model to a second sensor reading.

2. The computer-implemented method of claim 1, wherein the output indicates the repair action addressed the condition, the method further comprising:
adding the first sensor reading, the second sensor reading, and the repair action to a training data set at the beverage system; and
retraining the machine learning model on the training data set.

3. The computer-implemented method of claim 1, wherein the output indicates the repair action addressed the condition, the method further comprising:
transmitting the first sensor reading, the second sensor reading, the repair action, and the output to a cloud server; and
receiving an updated machine learning model from the cloud server, wherein the updated machine learning model was trained on a training data set comprising the first sensor reading, the second sensor reading, the repair action, and the output.

4. The computer-implemented method of claim 1, wherein the output indicates that the second sensor reading comprises the condition, the method further comprising:
transmitting the first sensor reading, the second sensor reading, the repair action, and the output to a cloud server;
receiving a second repair action from the cloud server, wherein the second repair action was generated by applying a machine learning model at the cloud server to the first sensor reading, the second sensor reading, the repair action, and the output;
executing the second repair action at the beverage system; and
generating a second output by applying the machine learning model at the beverage system to a third sensor reading, wherein the second output indicates that the second repair action addressed the condition.

5. The computer-implemented method of claim 1, further comprising:
generating an alert comprising the first sensor reading and the repair action;
sending the alert to a client device;
receiving a selected repair action from the client device; and
executing the selected repair action.

6. The computer-implemented method of claim 1, wherein the repair action comprises preventative maintenance.

7. The computer-implemented method of claim 1, wherein the first sensor reading comprises data from a plurality of sensors.

8. The computer-implemented method of claim 1, wherein the condition is an error associated with the beverage system.

9. The computer-implemented method of claim 1, wherein the first sensor reading is data from one of a camera, thermometer, accelerometer, humidity sensor, noise sensor, magnetometer, voltmeter, electrical current sensor, light sensor, infrared (IR) sensor, or vibration sensor.

10. A system, comprising:
a memory; and
at least one processor coupled to the memory and configured to:
apply a machine learning model to a first sensor reading, wherein the first sensor reading comprises a condition associated with a beverage system;
predict a repair action based on applying the machine learning model, wherein the repair action comprises a step to address the condition at the beverage system;
execute the repair action at the beverage system; and
generate an output by applying the machine learning model to a second sensor reading.

11. The system of claim 10, wherein the output indicates the repair action addressed the condition and the at least one processor is further configured to:
add the first sensor reading, the second sensor reading, and the repair action to a training data set at the beverage system; and
retrain the machine learning model on the training data set.

12. The system of claim 10, wherein the output indicates the repair action addressed the condition and the at least one processor is further configured to:
transmit the first sensor reading, the second sensor reading, the repair action, and the output to a cloud server; and
receive an updated machine learning model from the cloud server, wherein the updated machine learning model was trained on a training data set comprising the first sensor reading, the second sensor reading, the repair action, and the output.

13. The system of claim 10, wherein the output indicates that the second sensor reading comprises the condition and the at least one processor is further configured to:
transmit the first sensor reading, the second sensor reading, the repair action, and the output to a cloud server;
receive a second repair action from the cloud server, wherein the second repair action was generated by applying a machine learning model at the cloud server to the first sensor reading, the second sensor reading, the repair action, and the output;
execute the second repair action at the beverage system; and
generate a second output by applying the machine learning model at the beverage system to a third sensor reading, wherein the second output indicates that the second repair action addressed the condition.

14. The system of claim 10, wherein the at least one processor further configured to:
generate an alert comprising the first sensor reading and the repair action;
send the alert to a client device;
receive a selected repair action from the client device; and
execute the selected repair action.

15. The system of claim 10, wherein the repair action comprises preventative maintenance.

16. The system of claim 10, wherein the condition is an error associated with the beverage system.

17. A non-transitory computer-readable device having instructions stored thereon that, when executed by at least one computing device, cause the at least one computing device to perform operations comprising:
applying a machine learning model to a first sensor reading, wherein the first sensor reading comprises a condition associated with a beverage system;
predicting a repair action based on applying the machine learning model, wherein the repair action comprises a step to address the condition at the beverage system;
executing the repair action at the beverage system; and
generating an output by applying the machine learning model to a second sensor reading.

18. The non-transitory computer-readable device of claim 17, wherein the output indicates the repair action addressed the condition, the operations further comprising:
adding the first sensor reading, the second sensor reading, and the repair action to a training data set at the beverage system; and
retraining the machine learning model on the training data set.

19. The non-transitory computer-readable device of claim 17, wherein the output indicates the repair action addressed the condition, the operations further comprising:
transmitting the first sensor reading, the second sensor reading, the repair action, and the output to a cloud server; and
receiving an updated machine learning model from the cloud server, wherein the updated machine learning model was trained on a training data set comprising the first sensor reading, the second sensor reading, the repair action, and the output.

20. The non-transitory computer-readable device of claim 17, wherein the output indicates that the second sensor reading comprises the condition, the operations further comprising:
transmitting the first sensor reading, the second sensor reading, the repair action, and the output to a cloud server;
receiving a second repair action from the cloud server, wherein the second repair action was generated by applying a machine learning model at the cloud server to the first sensor reading, the second sensor reading, the repair action, and the output;
executing the second repair action at the beverage system; and
generating a second output by applying the machine learning model at the beverage system to a third sensor reading, wherein the second output indicates that the second repair action addressed the condition.
